(19) United States
(12) Patent Application Publication
(10) Pub. No.: US 2011/0204638 A1
(43) Pub. Date: Aug. 25, 2011

(54) WIND TURBINE WITH INTEGRATED ROTOR AND GENERATOR ASSEMBLY

(76) Inventor: Stuart Lahtinen, Cambridge, MN (US)

(21) Appl. No.: 13/034,272

(22) Filed: Feb. 24, 2011

Related U.S. Application Data
(60) Provisional application No. 61/308,066, filed on Feb. 25, 2010.

(51) Int. Cl. F03D 3/06; F03D 9/00; H02P 9/04

(52) U.S. Cl. 290/44; 416/197 A; 290/55

(57) ABSTRACT

A wind turbine and related methods for generating electrical current from wind energy. The wind turbine includes a rotatable substructure rotating about a vertical axis and a base assembly. A plurality of wind collectors are affixed to the periphery of the rotatable substructure and provide drag against wind passing the wind turbine to rotate the rotatable substructure. A plurality of permanent magnets are affixed to the rotatable substructure and rotate as the rotatable substructure turns. A plurality of wire windings are affixed to the base assembly such that the wire windings are exposed to magnetic fields of the permanent magnets as the substructure is rotated to generate an electrical current. The plurality of wire windings can be adapted to receive the electrical current and act as electromagnets for braking the rotatable substructure to slow or otherwise prevent the rotation of the rotatable substructure.

### RELATED APPLICATION

The present application claims the benefit of U.S. Provisional Application No. 61/308,066 filed Feb. 25, 2010 and entitled “WIND TURBINE WITH INTEGRATED ROTOR AND GENERATOR ASSEMBLY”, which is incorporated herein in its entirety by reference.

### FIELD OF THE DISCLOSURE

The present invention is generally directed to a wind turbine for generating electricity from wind. More specifically, the present invention is directed to a wind turbine having permanent magnets mounted to a rotatable substructure that rotates the permanent magnets past wire windings to generate electrical current.

### BACKGROUND OF THE DISCLOSURE

Wind turbines for generating electricity in their most basic form comprise a rotor having blades, scoops or other means of creating drag against moving wind to rotate the rotor, a drive shaft rotated by the rotor and a generator converting the rotational energy of the rotor to electrical energy. An electrical generator in its most basic form typically generates electricity using the rotational energy of the rotor to rotate, via the drive shaft, a permanent magnet contained within the generator near fixed wire windings also contained within the generator. Rotating the permanent magnet near the fixed wire windings allows the magnetic field generated by the permanent magnet to act on the fixed wire windings thereby generating electrical current in the wire windings. Typically, wind turbines fall into two general categories: horizontal axis wind turbines in which the rotor rotates about a horizontal axis parallel to the ground and vertical axis wind turbines in which the rotor rotates about a vertical axis perpendicular to the ground.

While relatively simple in concept, wind turbines must often employ a variety of complex mechanical systems to deal with ever changing wind conditions. Most conventional wind turbines employ a plurality of mechanical parts to convert the wind energy into electrical current. However, the more mechanical parts employed, the greater wind speed is required to overcome the friction of the mechanical parts and spin the rotor. Many horizontal axis wind turbines include complex mechanical systems to orient the rotor into the wind so as to maximize the wind energy captured by the rotor. Similarly, many wind turbine generators often include integrated transmission systems to insure that the drive shaft is rotating at a speed for generating an optimal current even if the rotor is rotating at less than optimal speeds due to low wind speeds. Many rotor assemblies also often comprise complex mechanical systems for controlling the efficiency of the rotor by altering the orientation of the blades relative to the wind or otherwise adjusting the amount of wind energy captured by the rotor. These additional mechanical systems, while increasing the overall efficiency of wind turbines, can substantially increase the cost and maintenance associated with operating wind turbines. A related drawback is that mechanical systems and particularly those directly related to the drive shaft are likely to become overheated due to the friction of the mechanical parts wearing against each other during the operation of the wind turbine.

A related concern is that exposure to wind speeds greatly exceeding ideal operating conditions can damage the generator or rotor assembly. Vertical axis wind turbines are particularly susceptible to damage as wind speeds can vary greatly along the length of the blade because the blades are attached to a base at a point close to the ground and consequently are susceptible to bending or deforming in strong winds. Vertical axis wind turbines often employ uniquely shaped blades and complex mechanicals systems controlling the orientation of the blades to minimize the risk of damage in high winds. Horizontal axis wind turbines are similarly susceptible to strong winds. Some horizontal axis wind turbines compensate for dangerous wind conditions by rotating the rotor blades to less efficient positions or rotating the rotor assembly out of the wind to capture less wind thereby reducing the rotational speed of the rotor blades. Similarly, many wind turbines include mechanical brakes to slow or even stop the rotation of the blades to prevent damage to the wind turbine.

Beyond the mechanical limitations of conventional wind turbines, the aesthetic appearance of conventional wind turbines is often a major hindrance to the widespread use of wind turbines, particularly in denser urban areas. Horizontal axis wind turbines typically require tall supports to provide sufficient clearance to rotate the rotor as well as requiring 360 degree clearance so as to allow the rotor assembly to compensate for changing wind directions. The height of horizontal axis wind turbines and large clearance required often limit the use to horizontal axis wind turbines to low population density areas such as rural areas. While vertical axis wind turbines do not require 360 degree clearance to rotate the rotor assembly, vertical axis turbines often require long vertically extending blades to capture sufficient wind to rotate the rotor assembly.

While a number of solutions have been proposed to address these technical and aesthetic problems, the solutions themselves often require complex and costly mechanical systems that require significant maintenance and often significantly increase the size and weight of the overall wind turbine. Similarly, many of the mechanical systems often decrease the efficiency of the overall wind turbine by adding additional friction to the system. As such, there is a need for a simple yet effective solution to address these technical and aesthetic problems.

### SUMMARY OF THE DISCLOSURE

A representative embodiment of a wind turbine according to the present invention comprises a rotatable substructure rotating around a vertical axis and having a plurality of permanent magnets affixed to the substructure such that the rotation of the substructure causes the magnets and their corresponding magnetic fields to pass between a plurality of fixed wire windings to generate an electrical current.

In one aspect, a representative wind turbine generally comprises a rotatable substructure and a base assembly. The rotatable substructure comprises a center axle defining a ring and a plurality of arms extending from the center axle to the outer ring. The rotatable substructure further comprises a plurality of permanent magnets adapted to rotate in a generally circular path as the rotatable substructure is rotated. A plurality of wind collectors are affixed to the ring and adapted to apply drag to wind moving past the rotatable substructure so as to rotate the rotatable substructure. The base assembly comprises an axle adapted to interface with the rotatable substructure such that rotatable substructure can rotate about the axle. A plurality of bearings can be disposed at the contact points between the base assembly and rotatable substructure to reduce friction between the base assembly and rotatable substructure. The base assembly further comprises a plurality of fixed wire windings positioned such that the wire winding are exposed to the magnetic fields of the plurality of permanent magnets as the rotatable substructure is rotated. The wire windings generate a current when the permanent magnets and their corresponding magnetic fields are passed proximate to the wire windings. Alternatively, the wire windings are adapted to act as electromagnets when a current is fed to the wire windings so as to allow the wire winding to perform a braking function with respect to the rotatable substructure if operating conditions so warrant.

The generator of the wind turbine according to the present invention is effectively integrated into the rotatable substructure eliminating the need for a separate drive shaft or transmission and thereby substantially reducing the friction that must be overcome to operate the wind turbine. The reduced friction that must be overcome allows the wind turbine to operate efficiently even at low wind speeds. The elimination of the drive shaft and transmission also reduces the overall weight of the wind turbine increasing the versatility of the wind turbine and adding to the types of locations that the wind turbine can be successfully operated in.

Similarly, the permanent magnets mounted to the rotatable substructure can also be used to prevent damage to the wind turbine in dangerous wind conditions. A current can be supplied directly to the wire windings thereby allowing the wire windings to function as electromagnets that act upon the permanent magnets to slow the rotatable substructure and avoid damaging the wind turbine in high wind conditions. The current can be supplied to the wire windings by an outside source or using electricity previously generated by the wind turbine and stored in batteries or by other means. Alternatively, some of the plurality of wire windings can be set to operate in the current generating mode so as to supply current to other magnet wire windings operating in braking mode. The ability of the magnet wire windings to essentially act as electromagnetic brakes eliminates the need for complex and heavy mechanical brakes which can damage the rotor assembly, increase cost and operating complexity and often require significant maintenance.

Another advantage of the present invention is that the integration of the generator with the rotatable substructure allows the wind turbine to have a small visual and operational profile. As the generator is effectively integrated with the rotatable substructure, the wind turbine does not require additional space for the generator and thereby can be relatively short in height. Similarly, because the wind turbine is a vertical axis wind turbine, the wind turbine does not require a tall support to raise the rotatable substructure to a height where large blades can rotate freely or require 360 degree clearance to orient the rotatable substructure toward changing wind directions. As such, the wind turbine of the present invention can operate in areas and environments unsuitable for conventional wind turbines.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE FIGURES

The invention can be completely understood in consideration of the following detailed description of various embodiments of the invention in connection with the accompanying drawings, in which:

FIG. 1 is a top, perspective view of a wind turbine according to the present invention.

FIG. 2 is a partial cross-sectional side view of the wind turbine of FIG. 1.

FIG. 3 is a partial cross-sectional side view of the wind turbine of FIG. 1 illustrating a plurality of permanent magnets positioned proximate to a plurality of magnet wire windings.

FIG. 4 is an exploded perspective view of the wind turbine of FIG. 1 with a portion of a rotatable substructure in section view.

FIG. 5 is a block diagram of an embodiment of a control system for a wind turbine according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE FIGURES

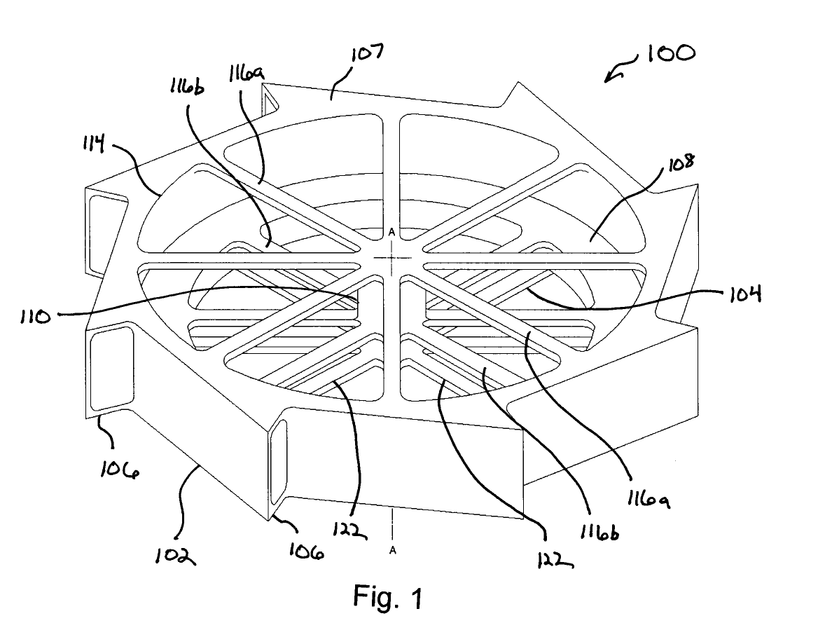

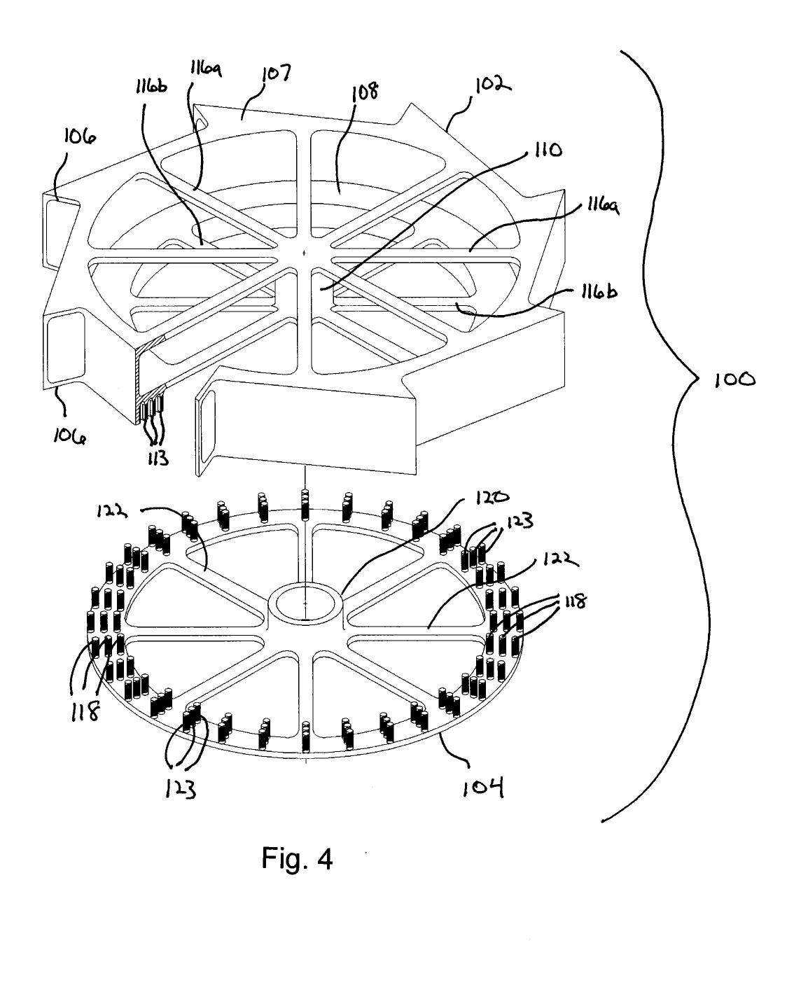

Referring to FIGS. 1, 2, 3 and 4, a wind turbine 100 according to the present invention comprises a rotatable substructure 102, a base assembly 104 and a plurality of wind collectors 106. Rotatable substructure 102 defines an upper surface 107 and a bottom surface 108 separated by a central hub 110. Pairs of corresponding arms 116a, 116b project outwardly from the central hub 110 to a perimeter ring 114 along the upper surface 107 and bottom surface 108. Bottom surface 108 further comprises a plurality of downward projections 113 having permanent magnets 117 mounted thereto. As rotatable substructure 102 is rotated, permanent magnets 117 travel in a generally circular path.

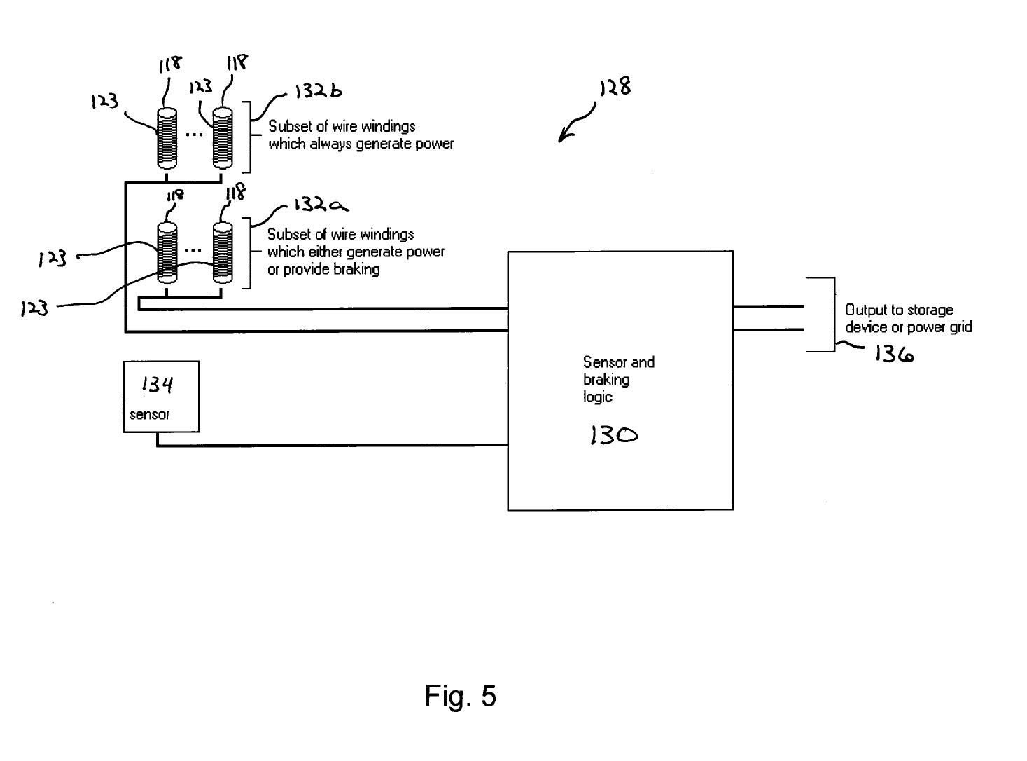

Base assembly 104 comprises a central axle 120 and a plurality of arms 122. Central axle 120 is adapted for insertion in the central hub 110 such that rotatable substructure 102 can rotate relative to the base assembly 104. Central axle 120 defines an axis a-a about which rotatable substructure 102 rotates. Central axle 120 can further comprise one or more bearings 124 at the contact points between central axle 120 and rotatable substructure 102 to reduce friction between rotatable substructure 102 and axle 120. Base assembly 104 further comprises a plurality of upward projections 118 extending upwardly from the arms 122. Each upward projection 118 includes a wire winding 123 wrapped about the upward projection 118. When rotatable substructure 102 is affixed to the base assembly 104, upward projections 118 are offset from the downward projections 113 such that the wire windings 123 are positioned between the permanent magnets 117 as the rotatable substructure 102 spins about axis a-a. Wire windings 123 generate an electrical current when exposed to the magnetic fields of the passing permanent magnets 117. The generated electrical current can be transmitted from the wire windings 123 to an onsite electrical storage system 136 such as, a battery based system, or alternatively, the electrical current can be transmitted directly to a power grid for consumption as illustrated in FIG. 5.

Referring to FIG. 5, an embodiment of wind turbine 100 can include a control system 128 wherein wire windings 123 are adapted to become electromagnets when supplied with electrical current and act on the permanent magnets 117 to slow the rotation of the rotatable substructure 102 relative to the base assembly 104. A controller 130 can selectively switch wire windings 123 between a current generating mode where wire windings 123 are generating electrical current and a braking mode where current is being supplied to wire windings 123 to brake rotatable substructure 102. The controller 130 can be adapted such that a first subset of wire windings 132a are set to braking mode while a remainder of wire winding subsets 132b remain in current generating mode to supply the first subset of wire windings 132a at least a portion of the current required to cause the first subset of wire windings 132a to operate as electromagnets. Controller 130 can comprise a simple logic controller such as, for example, relays or alternatively, controller 130 can comprise a processor based controller such as, for example, a Process Logic Controller or computer-based controller.

In a representative embodiment as illustrated in FIG. 5, wind turbine 100 can further comprise a sensor 134 adapted to measure the rotational speed of the rotatable substructure 102 relative to the base assembly 104. Controller 130 is operably linked to the sensor 134 such that the mode of wire windings 123 can be switched if dangerous operating conditions such as high winds are detected. Controller 130 receives the signal from the sensor 134 and selectively converts wire windings 123 from current generating mode to braking mode and back based on the rotational speed of the wind turbine 100. In an alternative embodiment, sensor 134 can be adapted to directly measure wind speed as opposed to measuring rotation of the wind turbine 100.

Plurality of wind collectors 106 are affixed to ring 114 of rotatable substructure 102 and adapted to provide drag against wind moving past the rotatable substructure 102, which causes the rotatable substructure 102 to rotate. Wind collectors 106 can comprise air scoops, blades and other conventional means for providing drag to wind moving past the rotatable substructure. Wind collectors 106 in the depicted embodiment are adapted to provide drag against wind originating from any direction travelling parallel to the plane of the rotatable substructure 102. In some applications, wind turbine 100 can be installed on a roof line engineered to amplify wind airflow and direct it toward the rotatable substructure 102 so as to promote operation and generation of electricity during periods of low wind speeds.

Rotatable substructure 102, base assembly 104 and wind collectors 106 can comprise stiff light weight materials adapted to resist deformation and fracture when subjected to the stresses associated with high wind velocities. The stiff light weight materials can include, but are not limited to carbon fiber, Kevlar composites, high tensile strength plastics such as high density polyethylene, and light weight metals such as aluminum.

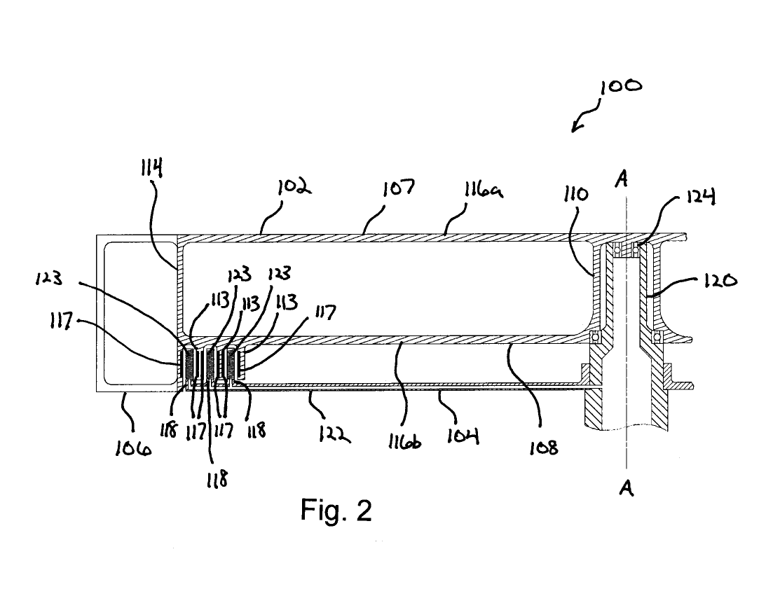

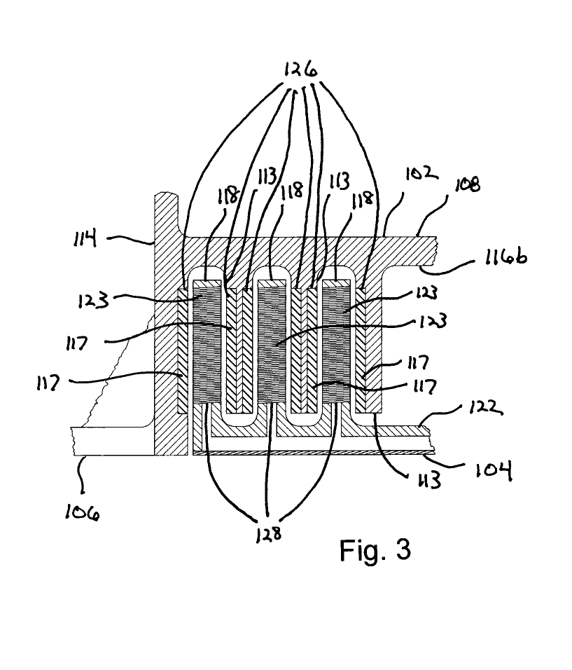

As shown in FIGS. 2-3, permanent magnets 117 can be affixed to downward projections 113 to form a magnet bank 126 while wire windings 123 are affixed to upward projections 118 to form a wire bank 128. Rotatable substructure 102 and base assembly 104 can be fabricated to have optimum numbers of magnet banks 126 and wire banks 128 for generation of electric current based on the desired power output as well as based upon expected operating conditions for the wind turbine 100. With the present invention, the number of magnet banks 126 and wire banks 128 need not be the same.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative embodiments.

What is claimed:

1. A wind turbine, comprising:
a wind collecting substructure rotating about a vertical axis, the wind collecting substructure including a plurality of magnets positioned about a peripheral ring of the wind collecting substructure, each magnet having a corresponding magnetic field; and
a base assembly including a plurality of wire windings affixed to the base assembly, wherein an electrical current is generated as the wind collecting substructure is rotated and the wire windings are exposed to the magnetic fields of the plurality of magnets.

2. The wind turbine of claim 1, wherein the wind collecting substructure includes a central hub and the base assembly includes a central axle, the central hub mounting over the central axle such that the wind collecting substructure rotates relative to the base assembly.

3. The wind turbine of claim 2, wherein the base assembly includes a plurality of base arms extending between the central axle and a base periphery, wherein each base arm includes at least one upward projection having one wire winding located thereon.

4. The wind turbine of claim 3, wherein the wind collecting substructure includes a plurality of substructure arms, wherein each substructure arm includes at least one downward projection having magnets located thereon.

5. The wind turbine of claim 3, further comprising:
a switch electrically connected to each wire winding, said switch adapted to selectively adjust each wire winding between a current generating mode and a rotation braking mode.

6. The wind turbine of claim 5, further comprising:
a control sensor for determining whether the switch is operating in the current generating mode or the rotation braking mode.

7. The wind turbine of claim 6, wherein the control sensor directly measures wind speed.

8. The wind turbine of claim 6, wherein the control sensor directly measures rotational speed of the wind collecting substructure.

9. The wind turbine of claim 5, wherein the switch individually adjusts each wire winding, such that at least one wire winding can be in the current generating mode while at least one wire winding is in the rotation braking mode.

10. A method for generating electricity, comprising:
providing a stationary base assembly including a plurality of wire windings affixed to the base assembly;
mounting a wind collecting substructure onto the stationary base, the wind collecting substructure including a plurality of magnets positioned about a peripheral ring of the wind collecting substructure; and
rotating the wind collecting substructure relative to the stationary base assembly such that magnets are rotated past the wire windings, wherein the wire windings are exposed to magnetic fields of the plurality of magnets to generate an electrical current.

11. The method of claim 10, wherein rotating the wind collecting substructure, further comprises:
collecting wind energy with a plurality of wind collectors positioned on an outer ring of the wind collecting substructure.

12. The method of claim 10, wherein mounting the wind collecting substructure onto the stationary base, further comprises:
mounting a central hub on the wind collecting substructure onto a central axle of the stationary base such that the wind collecting substructure rotates about a vertical axis defined by the central axis.

13. The method of claim 10, further comprising:
controlling a rate of rotation of the wind collecting substructure relative to the stationary base.

14. The method of claim 13, wherein controlling the rate of rotation comprises:
powering at least one wire winding to create an electromagnet, wherein the electromagnet interacts with the magnetic fields to provide a braking function to the wind collecting substructure.

15. The method of claim 13, wherein controlling the rate of rotation, further comprises:
directly measuring wind speed.

16. The method of claim 13, wherein controlling the rate of rotation, further comprises:
directly measuring a rotation speed of the wind collecting substructure.
